(19) United States
(12) Patent Application Publication
(10) Pub. No.: US 2023/0107370 A1
(43) Pub. Date: Apr. 6, 2023

(54) COMPUTER-GENERATED THREE-DIMENSIONAL DATA VISUALIZATION

(71) Applicant: MARKFORGED, INC., Watertown, MA (US)

(72) Inventors: Cole Smith, Providence, RI (US); Corinne Drysdale, Boston, MA (US); Bruce David Jones, Sudbury, MA (US); David Steven Benhaim, Miami, FL (US); Benjamin Hodsdon Gallup, Acton, MA (US)

(21) Appl. No.: 17/955,919

(22) Filed: Sep. 29, 2022

Related U.S. Application Data
(60) Provisional application No. 63/249,701, filed on Sep. 29, 2021.

(51) Int. Cl. G06T 17/00; G06T 19/20

(52) U.S. Cl. CPC G06T 17/00; G06T 19/20; G06T 2219/2012

(57) ABSTRACT

Methods for generating a visualization of 3D data for a manufactured part are disclosed. The methods include scanning a part to obtain a digital representation, comparing the digital representation with a 3D model, and generating the visualization of the part having color and pattern shading to display portions of the part that topographically differ between the digital representation and the 3D model. Visualizations of 3D data for a manufactured part including a digital representation of the manufactured part as compared with a 3D model of the part are disclosed. The digital representation of the manufactured part illustrates the part having color and pattern shading to display portions of the part that topographically differ between the digital representation and the 3D model.

### CROSS-REFERENCE TO RELATED APPLICATIONS

This application claims priority under 35 U.S.C. § 119(e) to U.S. Provisional Application Serial No. 63/249,701, titled “COMPUTER-GENERATED THREE-DIMENSIONAL DATA VISUALIZATION” filed Sep. 29, 2021, which is incorporated herein by reference in its entirety for all purposes.

### FIELD OF TECHNOLOGY

Aspects and embodiments disclosed herein relate to visualizing data corresponding to printed parts produced from a digital represented of the printed part against a 3D model of the printed part.

### SUMMARY

In accordance with an aspect, there is provided a method for generating a visualization of 3D data for a manufactured part. The method may include scanning a part to obtain a digital representation. The method may include comparing the digital representation with a 3D model. The method further may include generating the visualization of the part having color and pattern shading to display portions of the part that topographically differ between the digital representation and the 3D model.

In some embodiments, the visualization comprises one or more surface peaks and/or valleys that are not present in the 3D model.

In some embodiments, the color and pattern shading of the visualization indicates parts of a surface of the manufactured part that may be topographically out of specification with respect to the 3D model.

In some embodiments, different shades of a color in the visualization indicate different depth ranges of a valley of the digital representation below a surface of the 3D model. For example, different shades of a color in the visualization may indicate different depth ranges of a peak of the digital representation below a surface of the 3D model. Alternatively, or in addition, different shades of a color in the visualization indicate different heights ranges of a peak above a surface of the 3D model.

In further embodiments, the method may include setting a threshold for designating a point or area in the visualization as a peak or valley.

In some embodiments, the color and pattern shading of the visualization may indicate a difference between the digital representation and the 3D model. As an example, the color and pattern shading of the visualization may indicate a topographical difference between the digital representation and the 3D model by degree or extent. The visualization may display a change in the color and pattern shading of the visualization when the topographical difference between the digital representation and the 3D model is within an acceptable range, e.g., within the boundaries of a threshold range. In particular embodiments, the visualization may display a change in the color and pattern shading of the visualization when the topographical difference between the digital representation and the 3D model is greater than the acceptable range. In other embodiments, the visualization may display a change in the color and pattern shading of the visualization when the topographical difference between the digital representation and the 3D model is less than the acceptable range. In some embodiments, the color and pattern shading of the visualization may correspond to an amount and direction of a deviation from an expected parameter in a specification of the manufactured part.

In some embodiments, variations of the color and pattern shading of the visualization may correspond to differences in data pertaining to the topographical differences between the digital representation and the 3D model. In some embodiments, a direction of the pattern shading indicates a peak or valley in the visualization of the part. In some embodiments, a direction of cross-hatching in the pattern shading may indicate a peak or valley in the visualization of the part. In some embodiments, symbols in the pattern shading may indicate a peak or valley in the visualization of the part.

In some embodiments, the method may include configuring parameters of the color and pattern shading of the visualization of the part.

In further embodiments, the method may include translating the color and pattern shading of the visualization of the part to a grayscale visualization.

In accordance with an aspect, there is provided a visualization of 3D data for a manufactured part. The visualization may include a digital representation of the manufactured part as compared with a 3D model of the part. The digital representation may illustrate the manufactured part having color and pattern shading to display portions of the manufactured part that topographically differ between the digital representation and the 3D model.

In some embodiments, the topographically different portions of the part comprise one or more surfaces peaks and/or valleys that are not present in the 3D model. In some embodiments, the color and pattern shading of the digital representation may indicate parts of a surface of the manufactured part that may be topographically out of specification as compared to the 3D model. In some embodiments, the color and pattern shading of the digital representation may indicate a difference between the manufactured part and the 3D model. For example, the color and pattern shading of the digital representation may indicate a topographical difference between the manufactured part and the 3D model by degree or extent.

In some embodiments, different shades of a color in the digital representation may indicate different depth ranges of a valley of the manufactured part below a surface of the 3D model. In some embodiments, different shades of a color in the digital representation may indicate different heights ranges of a peak of the manufactured part above a surface of the 3D model.

In some embodiments, a direction in the pattern shading of the digital representation may indicate a peak or valley of the manufactured part. In some embodiments, cross-hatching in the pattern shading of the digital representation may indicate a peak or valley of the manufactured part. In some embodiments, symbols in the pattern shading of the digital representation may indicate a peak or valley of the manufactured part.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates an example of a visualization of differences between the surfaces of a printed part and the CAD surface.

FIG. 2 illustrates a color visualization of imperfections in a printed part and a grayscale version of the same visualization.

FIG. 3 illustrates examples of color and pattern shading according to an embodiment.

FIG. 4 illustrates an example of color and pattern shading translated to grayscale.

FIG. 5 illustrates additional examples of grayscale visualizations including legends.

FIG. 6 illustrates another example of a visualization according to an embodiment when viewed in color.

FIG. 7 illustrates an example of halftoning, albeit not in the field of 3D printing.

FIG. 8 illustrates an example of using a color tone. Alternatively, color bands may be used.

FIG. 9 illustrates an example of data values classified into bands of values, in order to simplify the visualization and improve visibility using a smaller number of colors corresponding to those bands.

FIG. 10A illustrates an example of a visualization of part surface deviation with a discretized color scale.

FIG. 10B illustrates an example of a visualization of part surface deviation with a linear color scale.

FIG. 11 illustrates an example of a pattern being switched “on” or “off” depending on where each (x, y) coordinate falls relative to a pattern template. In this example, the triangle delineates the surface area where the pattern is to be applied (e.g., because there is a triangular peak or valley beyond accepted tolerance).

FIGS. 12A and 12B illustrate an example of generating a pattern by repeating a shape (in this case, pinstripes) over a surface.

FIG. 13 illustrates an example comparison of the same visualization as seen by individuals with full color vision (top left), protanomaly (top right), tritanomaly (bottom left), and monochromacy (bottom right).

FIG. 14 illustrates an example of using a symbol to illustrate a direction of slope of an imperfection.

FIG. 15 is a flow diagram of an example of operations for computer-generated 3D data visualization according to an embodiment.

FIG. 16 is a block diagram of an example of a computer system 1600 according to an embodiment.

The features and advantages of the disclosure are apparent from the detailed specification, and thus, it is intended that the appended claims cover all systems and methods falling within the true spirit and scope of the disclosure. As used herein, the indefinite articles “a” and “an” mean “at least one” or “one or more.” Similarly, the use of a plural term does not necessarily denote a plurality unless it is unambiguous in the given context. Words such as “and” or “or” mean “and/or” unless specifically directed otherwise. In this application, the terms “comprising” and “including” may be understood to encompass itemized components or steps whether presented by themselves or together with one or more additional components or steps. Unless otherwise stated, the terms “about” and “approximately” may be understood to permit standard variation as would be understood by those of ordinary skill in the art. Where ranges are provided herein, the endpoints are included. As used in this application, the term “comprise” and variations of the term, such as “comprising” and “comprises,” are not intended to exclude other additives, components, integers or steps.

As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Many methodologies described herein include a step of “determining.” Those of ordinary skill in the art, reading the present specification, will appreciate that such “determining” can utilize or be accomplished through use of any of a variety of techniques available to those skilled in the art, including for example specific techniques explicitly referred to herein. In some embodiments, determining involves manipulation of a physical sample. In some embodiments, determining involves consideration and/or manipulation of data or information, for example utilizing a computer or other processing unit adapted to perform a relevant analysis. In some embodiments, determining involves receiving relevant information and/or materials from a source. In some embodiments, determining involves comparing one or more features of a sample or entity to a comparable reference.

As used herein, the term “substantially,” and grammatic equivalents, refer to the qualitative condition of exhibiting total or near-total extent or degree of a characteristic or property of interest. One of ordinary skill in the art will understand that chemical phenomena rarely, if ever, go to completion and/or proceed to completeness or achieve or avoid an absolute result.

### DETAILED DESCRIPTION

Techniques for three-dimensional (3D) printing include subtractive manufacturing and additive manufacturing. Both subtractive manufacturing and additive manufacturing use program instructions and/or object models encoded in print files. A 3D printer reads a print file and prints a 3D object (also referred to herein as a “part”) according to the instructions and/or model(s) encoded in that file. Some non-limiting examples of print file formats used by 3D printers include MFP, STL, OBJ, AMF, 3MF, IGES or IGS, and STEP. In some cases, program instructions and/or models for 3D printing are produced based on computer-aided drafting (CAD) design files.

In subtractive manufacturing, 3D objects are manufactured by cutting away material from an initial block (or other shape) of material. For example, computer numeric controlled (CNC) machines may be initialized and tuned by an operator to create a particular object. The operator may supply a program (e.g., using G-code) that instructs the machine how to make the object. An input material larger than the desired object is provided to the machine. The machine’s tool (or multiple tools, depending on the machine) carves away the material, according to the program, to reveal the shape of the specified object.

In additive manufacturing, 3D objects are manufactured by adding layer-upon-layer of material. For example, based on a digital model of a 3D object, an additive manufacturing based 3D printing device can create the object by depositing a part material along toolpaths in a layer-by-layer manner. A print head of the 3D printing device or system carries a nozzle, which deposits the part material as a sequence of roads on a substrate in a build plane. The deposited part material fuses to previously deposited part material and is then solidified. The position of the print head relative to the substrate is then incremented along one or more print axes, and the process can then be repeated to form a 3D object resembling the 3D computer model.

A 3D object produced by 3D printing can have imperfections relative to the 3D computer model. One or more surfaces may include “peaks” (i.e., protrusions of too much material for that location) and/or “valleys” (i.e., indentations of too little material for that location) that are not present in the 3D computer model. These imperfections may be caused, for example, by imperfections in the machinery, material, or the software that operates the machinery. To detect imperfections, a laser scanner or other kind of 3D scanning device may be used to generate a 3-dimensional surface image of the printed part. The surface image may be computationally compared with the surface defined by the 3D computer model and a visualization may be generated that shows the differences.

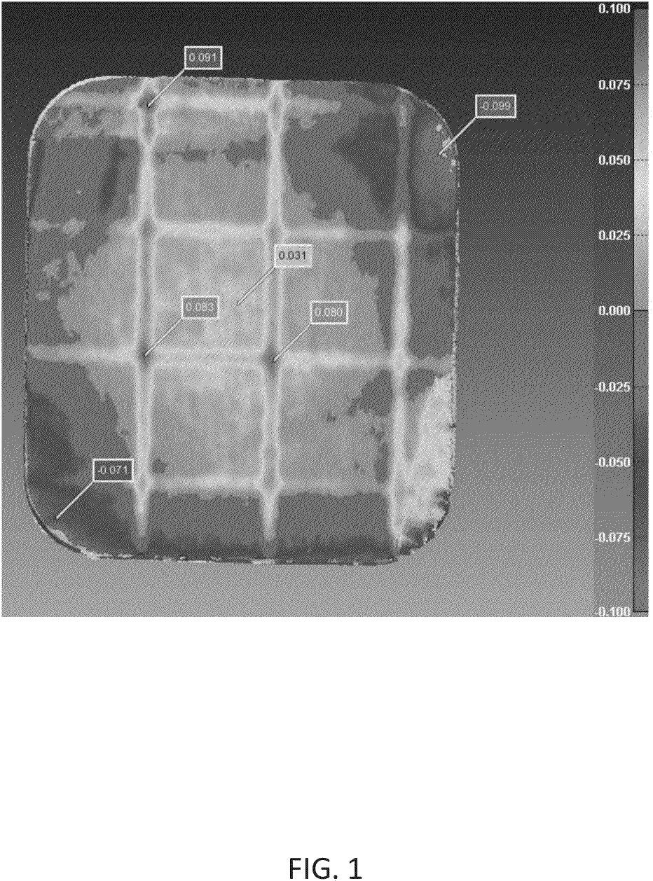

With reference to FIG. 1, blue regions at the edges of the image indicate valleys in the printed surface that exceed the acceptable tolerance, and red regions in the center of the image indicate peaks in the printed surface that exceed the acceptable tolerance. As demonstrated by FIG. 1, the imperfections and their respective directions (i.e., peaks or valleys) can be difficult to discern in this kind of visualization - particularly if translated to grayscale as discussed below.

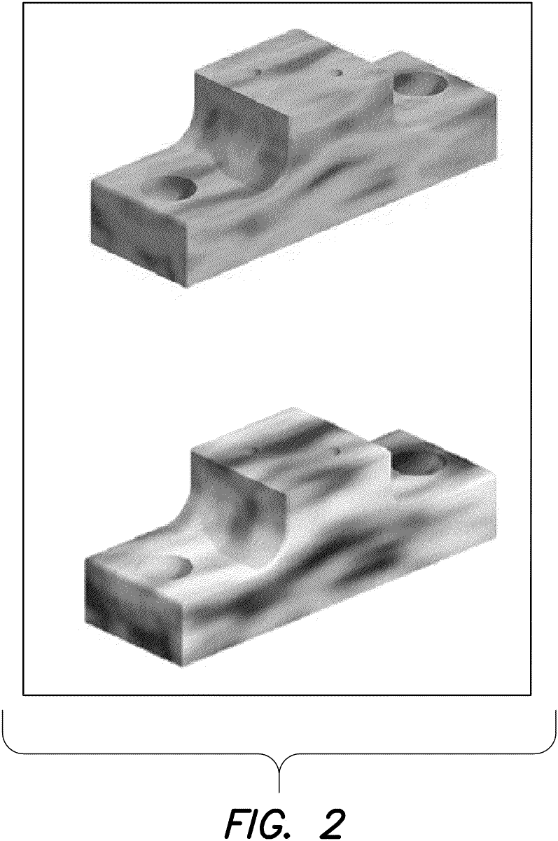

Even when using different colors, a broader color gradient, and/or higher surface resolution, this kind of visualization does not translate well to grayscale (e.g., grayscale computer monitors or grayscale printers), such as illustrated in FIG. 2. For example, one or more embodiments described herein include techniques for visualizing imperfections in printed parts that are more readily discernible than the kinds of visualizations described above, even when translated to grayscale.

A method for computer-generated 3D data visualization according to an embodiment may include printing a part using a 3D printer. The method may further include scanning the printed part to obtain a digital representation of at least part of the surface of the printed part. The method may further include comparing the digital representation of the at least part of the surface of the printed part with the 3D computer model, to identify imperfections in the printed part. The method may further include generating a visualization of the at least part of the surface of the printed part. The visualization may include color and/or pattern shading that indicates parts of the surface that may be topographically out of specification (i.e., peaks and/or valleys). The color and/or pattern shading may be determined using techniques described below.

Color and/or pattern shading as described herein allows an operator to quickly understand the part - i.e., where there are imperfections, in what direction, and to what extent. In addition, color and/or pattern shading as described herein, when translated to grayscale, is more readily understood than prior approaches.

In an embodiment, in color renderings, a particular color (e.g., blue) or range of colors (e.g., shades of blue) indicate areas of the printed part that are below the expected surface. Another color (e.g., red) or range of colors (e.g., shades of red) may indicate areas of the printed part that are above the expected surface.

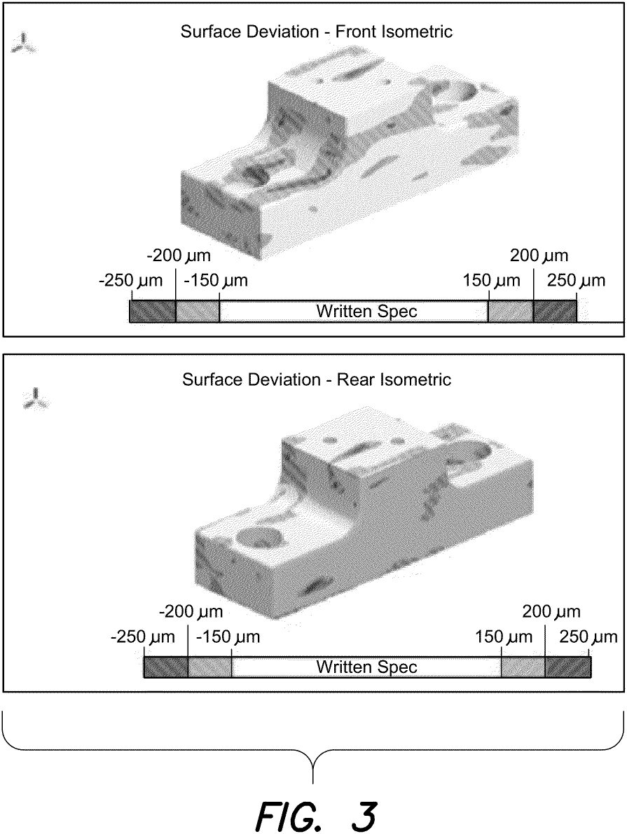

In these examples, such as illustrated in FIG. 3, different shades of blue indicate different depth ranges of valleys, and different shades of red/orange indicate different height ranges of peaks. Additionally, different directions of respective patterns also help differentiate between peaks and valleys when the visualization is translated to grayscale. White corresponds to printed surface that matches expectations or deviates within acceptable tolerances.

In an embodiment, color/pattern bands are user-configurable. For example, one or more thresholds associated, respectively, with one or more color/pattern bands corresponding to one or more acceptable tolerances, i.e., an acceptable range, may be user-configurable. A user interface may include controls for setting a threshold (e.g., an amount or percent of deviation) for designating a point or area as a peak or valley, or different thresholds for peaks and valleys respectively. In this configuration, the visualization displays a change, e.g., in the color and pattern shading of the visualization, when the topographical difference between the digital representation and the 3D model is within an acceptable range as defined by the user. For example, the visualization can display a change, e.g., in the color and pattern shading of the visualization, when the topographical difference between the digital representation and the 3D model is greater than the acceptable range, e.g., as defined by the user, i.e., in the specification for a part. The visualization can also display a change, e.g., in the color and pattern shading of the visualization, when the topographical difference between the digital representation and the 3D model is less than the acceptable range, e.g., as defined by the user, i.e., in the specification for a part.

In an embodiment, a method for pattern shading includes rendering a 3D object with color corresponding to the value of some quantity (for example, representing an amount and direction of deviation from expectation, e.g., a specification) that varies over the surface of the object. The method may include locally adjusting the color to produce a pattern. Different patterns may correspond to respective “value bands” of the data. In the visualization, the pattern may retain the same orientation relative to the viewer regardless of the surface orientation of the object being viewed. Visually, the effect may be as though viewing the data through a patterned lens, or a “green screen” type filter where each pattern is projected onto the corresponding part(s) of the surface.

Variations of colors and/or patterns may be used to represent differences in the data. For example, positive values may correspond to peaks and negative values may correspond to valleys, or vice versa. As in the example of FIG. 3, different patterns may correspond to different “signs” (positive or negative) of the data. For example, viewing a pattern from left to right, a downward line trend may indicate a valley and an upward line trend may indicate a peak. Alternatively or additionally, different colors and/or patterns may correspond to different ranges of values, even having the same sign. The visualization may include a color bar or legend with reproductions of the different patterns, indicating their respective significances.

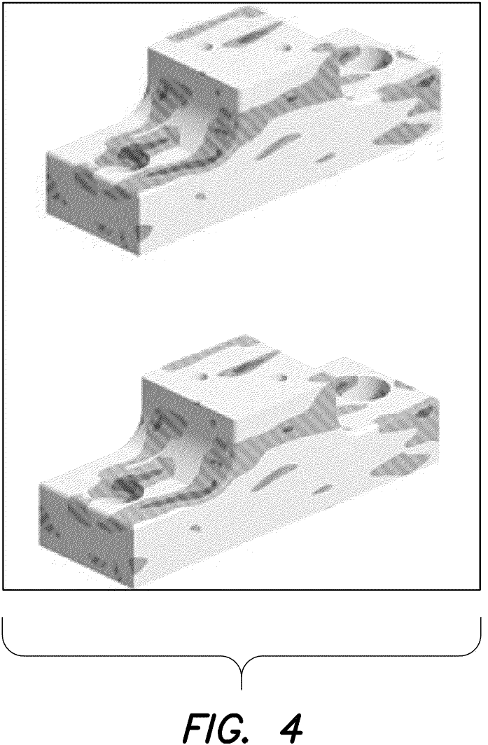

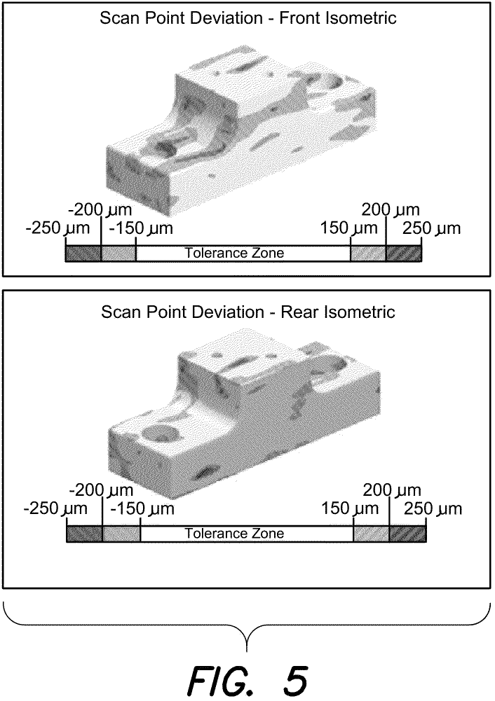

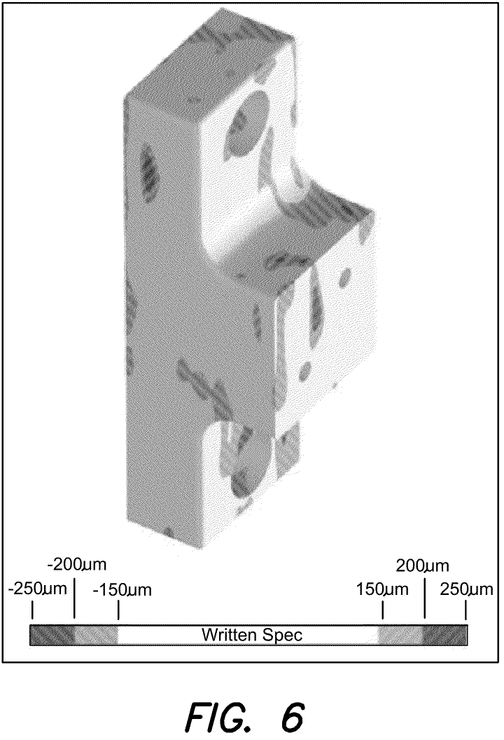

In FIG. 4, the pinstripes in the blue areas trend downward from left to right, indicating valleys. As further demonstrated by FIG. 4, in the grayscale version, the pattern provides a readily discernible indicator of the imperfection than is possible with a grayscale tone alone. The pattern provides a bidirectional visual scale even in black-and-white that is visible, providers quick insight into the nature of the imperfection, and is not distracting. In some embodiments, grayscale translation includes selecting color tones of identical luminosity such that positive and negative regions appear the same shade of gray after translation.

Examples illustrated herein include cross-hatching (or “pinstripes”) as an example pattern. Other kinds of patterns may be used to represent value ranges in the surface data. For example, a visualization may include one or more patterns of spirals, meanders, waves, foams, tiling, cracks, and/or another kind of pattern or combination thereof. As another example, a pattern may include one or more tiled/repeating symbols, characters (e.g., words or numbers), series of symbols and/or characters (e.g., the character “+” to represent a peak and the character “-” to represent a valley), a company logo, and the like. In some examples, varying textures may be applied to a printed document, with different textures serving a similar function as different visual patterns. Varying textures may also be combined with different visual patterns associated with each texture.

In an embodiment, a pattern scale may vary such that it is always visible regardless of feature size. Using this approach, for the pattern to be discernible, the scale of a feature (e.g., a portion of the object geometry and/or a “blob” representing a region of the data) must be larger than the characteristic scale of the pattern. Alternatively, a pattern scale may vary according to local feature size.

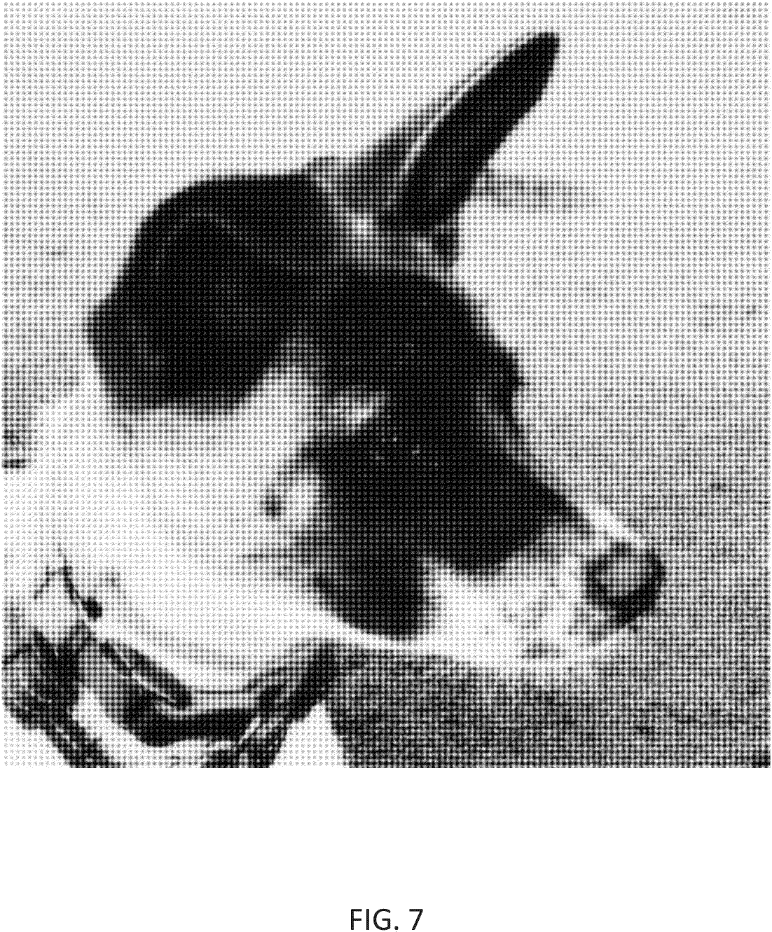

In an embodiment, a pattern may be generated using a halftone effect. Regions corresponding to different data ranges (e.g., that would be assigned different colors in a color visualization) may be rendered “halftoned.” For example, a halftone effect, such as illustrated in FIG. 7, may use circles, where circle size indicates scale of the data value and/or that the data value is within some band of values.

One approach to varying color along a gradient is to use a range of values corresponding to white at one end of the range and black at the other end of the range. For example, a value of 0 may correspond to white, a value of 1 may correspond to black, and values between 0 and 1 may correspond to different shades of gray. An extension of this concept would be to use some kind of colormap.

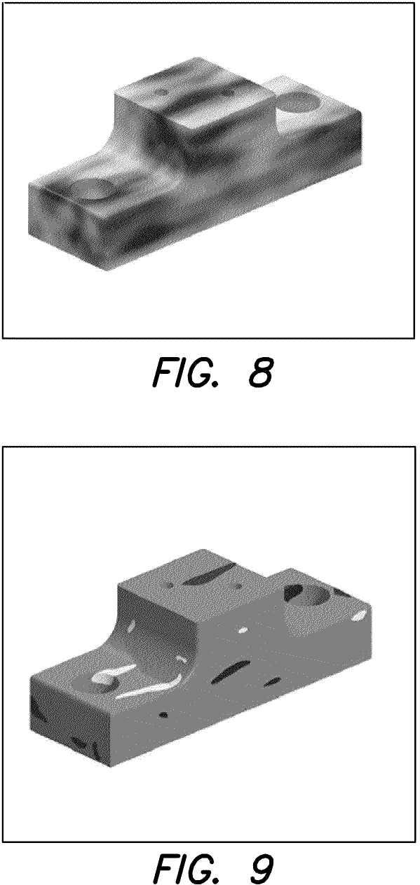

FIG. 8 illustrates an example of using a color tone. Alternatively, color bands may be used without a gradient. FIG. 9 illustrates an example of data values classified into bands of values, in order to simplify the visualization and improve visibility using a smaller number of colors corresponding to those bands. In FIG. 9, the majority of the part is one uniform color and the specific regions of higher and lower spots on the part are illustrated in shades of gray trending towards black and white, respectively. However, some colormaps do not translate effectively to grayscale. Alternatively, different patterns may be used without using a color gradient or band-based coloring at all.

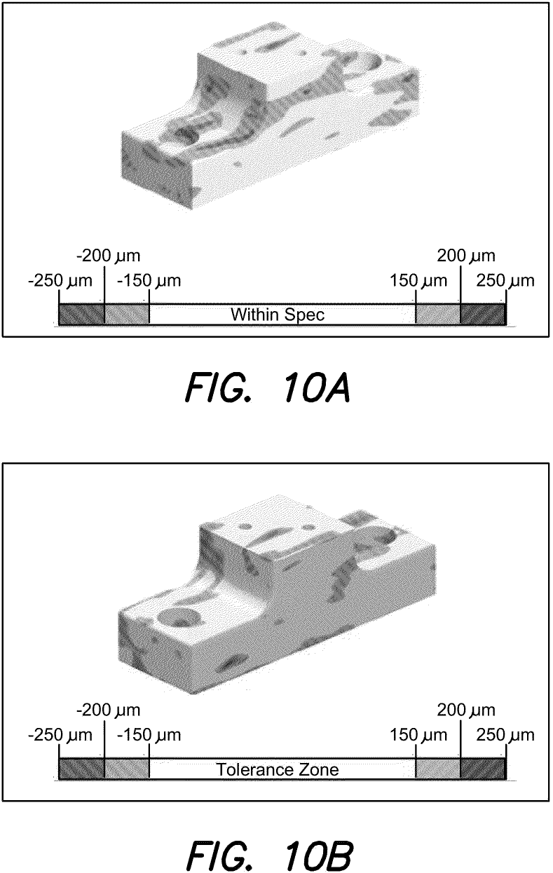

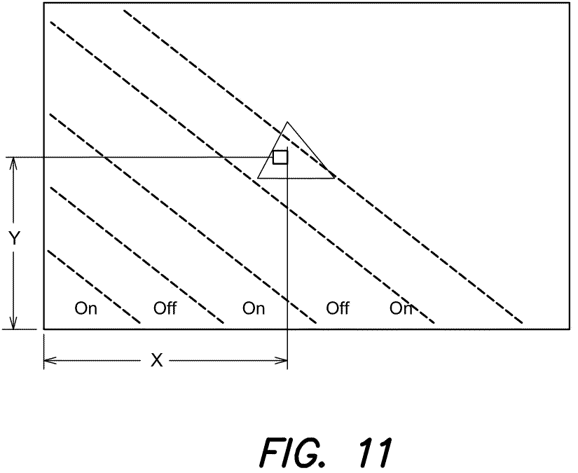

FIG. 10A illustrates an example of a visualization of part surface deviation with a discretized color scale. FIG. 10B illustrates an example of a visualization of part surface deviation with a linear color scale.

In an embodiment, patterns are user-configurable. For example, a user interface may include controls to select from available patterns and/or provide one or more custom patterns (e.g., a logo, user-supplied, text, and the like). The scale and/or other parameters (e.g., line width, distance between lines, and the like) of a pattern may be user-configurable. The number of patterns (e.g., two patterns or another number of patterns) and/or number of color bands (e.g., four color bands or another number of color bands) may be user-configurable.

One or more embodiments use (x, y) positioning in a visualization (i.e., on the screen or printing substrate, such as printer paper) to determine color/pattern changes at each point, in order to display one or more patterns on the surface. For example, as illustrated in FIG. 11, at the specific point within the triangle — and at every other (x, y) coordinate that is (a) within the triangle and (b) within the “on” region for the pattern — the pattern would be switched “on” and therefore displayed at that point in the visualization. At (x, y) coordinates that are (a) within the triangle and (b) within the “off” region for the pattern, the pattern would be switched “off” and therefore not displayed at that point in the visualization. The resulting effect is a crosshatch pattern achieved by overlaying the on/off bands. Overlaying the on/off bands may replace the underlying color in that location (e.g., by overlaying a black band), or may perform a local adjustment to color (e.g., by darkening a shade of red, blue, or other color that coincides with the band).

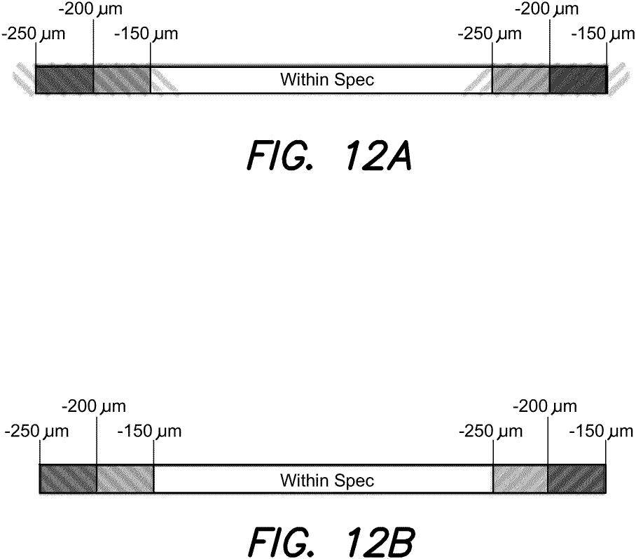

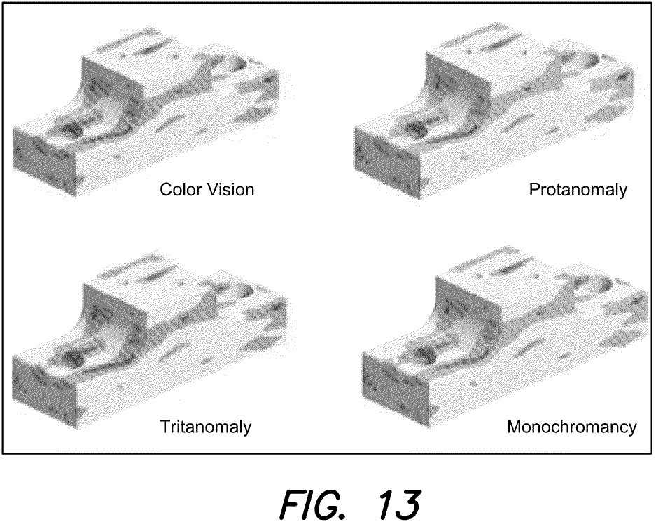

FIGS. 12A and 12B illustrate an example of generating a pattern by repeating a shape over a surface. This approach is illustrated here by way of example using a legend bar. FIG. 12A shows the pattern overlaid with the color bands, and FIG. 12B shows the pattern applied and confined within the color bands. This approach may alternatively or additionally be used on a visualization of a 3D part surface.

One or more embodiments allow for improved comprehension of visualizations even for a range of color perspectives. As FIG. 13 demonstrates, approaches described herein allow for effective visualization even when color perception is limited - whether by the human eye, such as in the protanomaly, i.e., red deficient, or tritanomaly, i.e., blue deficient, representation or the color range provided by the visualization medium (e.g., screen or paper printer).

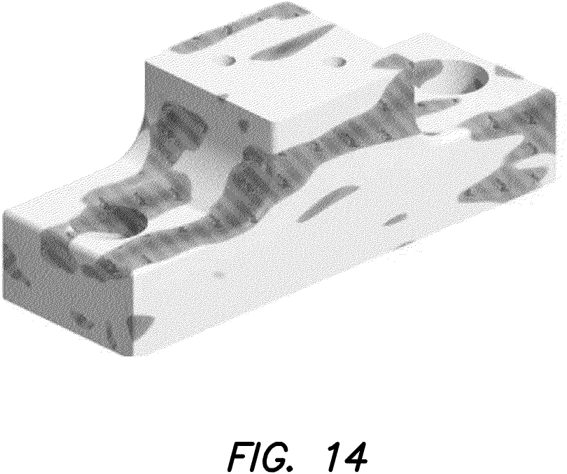

FIG. 14 illustrates an example of using a symbol to illustrate a direction of slope of an imperfection. In this example, the direction of travel of a downhill skier represents the direction of the slope of a valley (i.e., “downhill” in the direction of travel).

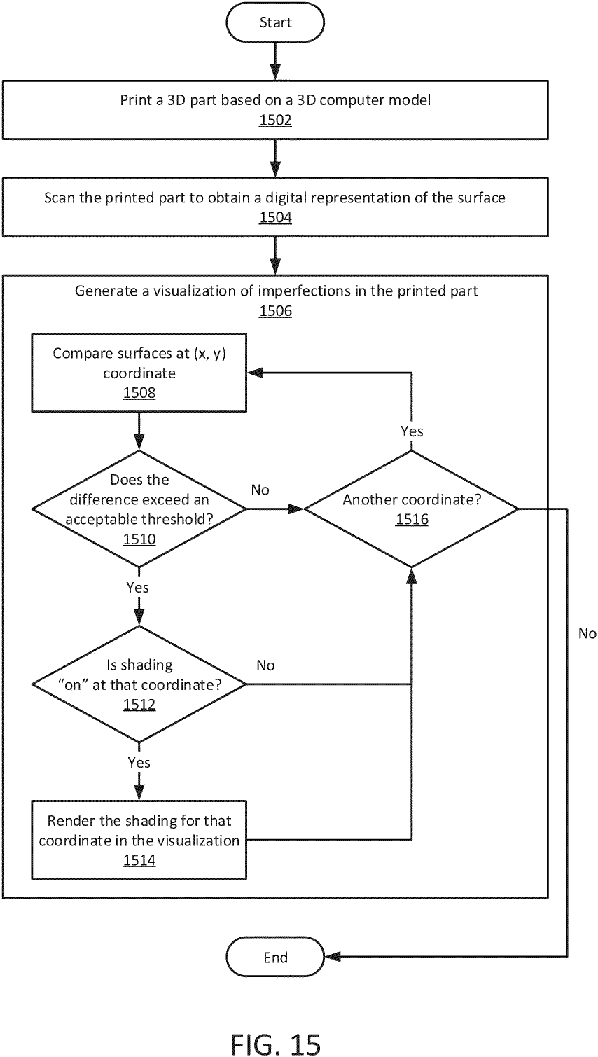

FIG. 15 is a flow diagram of an example of operations for computer-generated 3D data visualization according to an embodiment. One or more operations illustrated in FIG. 15 may be modified, rearranged, or omitted all together. Accordingly, the particular sequence of operations illustrated in FIG. 15 should not be construed as limiting the scope of one or more embodiments.

With reference to FIG. 15, a system prints a 3D part based on a 3D computer model (Operation 1502), using additive and/or subtractive 3D printing. The system scans the printed part to obtain a digital representation of at least part of the surface of the printed part (Operation 1504). Based on the 3D computer model and the digital representation of the at least part of the surface of the printed part, the system generates a visualization of imperfections in the printed part (Operation 1506). Specifically, the visualization shows at least part of the surface of the printed part, with color and/or pattern shading indicating the locations of peaks and/or valleys (if any) that exceed acceptable tolerances.

To generate the visualization, the system may compare the surfaces of the 3D computer model and the digital representation of the printed part at a particular (x, y) coordinate (Operation 1508). The comparison generates a value that indicates a difference between the surfaces at that coordinate. The system determines whether the difference exceeds an acceptable threshold (Operation 1510). If the difference exceeds the acceptable threshold, then the system may determine whether shading is “on” at that coordinate (Operation 1512). For example, the system may be configured to apply bands of shading as described herein with reference to FIG. 11. If shading is “on” at that coordinate, then the system renders the appropriate shading (e.g., shading configured to represent a peak or a valley, within a particular band of values) for that coordinate in the visualization (Operation 1514). The system may then determine whether there is another coordinate at which to compare surfaces (Operation 1516). The system may compare the values at coordinates across the surface, starting from a logical origin and proceeding “width”-first (incrementing coordinates along the logical x-axis) or “height”-first (incrementing coordinates along the logical y-axis). Alternatively, comparisons may be performed in another manner. For example, the system may average values over a set of adjacent coordinates that form an area of the surface, and apply shading to that area as a whole. If there are no more coordinates to compare (as determined in Operation 1516), the generating the visualization may be complete. The visualization may be rendered along with a legend, descriptive text, part specifications, and/or other features.

One or more embodiments described herein include techniques to communicate the value of a quantity that varies over a 3-dimensional surface. Techniques described herein allow for translating the visualization to grayscale while retaining a similar amount of visual information. Thus, for example, techniques described herein facilitate grayscale printing of documents that are normally viewed or intended to be viewed in color. In addition, techniques described herein allow viewers with limited color vision to parse color-coded information. One or more embodiments remove ambiguity in the color bands within rendered data, such that variations in color do not diminish the communicated data.

In an embodiment, one or more components of a system for computer-generated 3D data visualization as described herein are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In an embodiment, a user interface includes hardware and/or software configured to facilitate communications between a user and a 3D data visualization system. A user interface renders user interface elements and receives input via user interface elements. A user interface may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms. Different components of a user interface may be specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface may be specified in one or more other languages, such as Java, Python, Perl, C, C++, and/or any other language or combination thereof.

Detailed examples are described herein for purposes of clarity. Components and/or operations described herein should be understood as examples that may not be applicable to one or more embodiments. Accordingly, components and/or operations described herein should not be construed as limiting the scope of one or more embodiments.

In an embodiment, a system includes one or more devices, including one or more hardware processors, that are configured to perform any of the operations described herein.

In an embodiment, one or more non-transitory computer-readable storage media store instructions that, when executed by one or more hardware processors, cause performance of any of the operations described herein.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

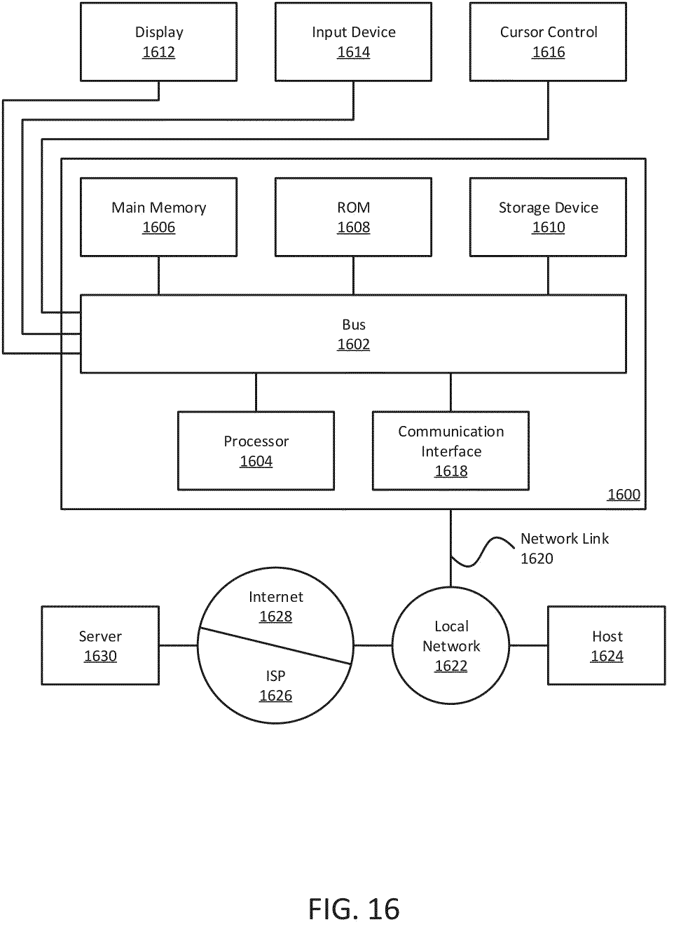

With reference to FIG. 16, computer system 1600 includes a bus 1602 or other communication mechanism for communicating information, and a hardware processor 1604 coupled with the bus 1602 for processing information. Hardware processor 1604 may be a general-purpose microprocessor.

Computer system 1600 also includes a main memory 1606, such as a random access memory (RAM) or other dynamic storage device, coupled to bus 1602 for storing information and instructions to be executed by processor 1604. Main memory 1606 also may be used for storing temporary variables or other intermediate information during execution of instructions to be executed by processor 1604. Such instructions, when stored in one or more non-transitory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to an output display 1612, such as a liquid crystal display (LCD), plasma display, electronic ink display, cathode ray tube (CRT) monitor, or any other kind of device for displaying information to a computer user. An input device 1614, including alphanumeric and other keys, may be coupled to bus 1602 for communicating information and command selections to processor 1604. Alternatively or additionally, computer system 1600 may receive user input via a cursor control 1616, such as a mouse, a trackball, a trackpad, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane. Alternatively or additionally, computer system 16 may include a touchscreen. Display 1612 may be configured to receive user input via one or more pressure-sensitive sensors, multi-touch sensors, and/or gesture sensors. Alternatively or additionally, computer system 1600 may receive user input via a microphone, video camera, and/or some other kind of user input device (not shown).

With continued reference to FIG. 16, computer system 1600 may implement the techniques described herein using customized hard-wired logic, one or more ASICs or FPGAs, firmware, and/or program logic which in combination with other components of computer system 1600 causes or programs computer system 1600 to be a special-purpose machine. According to one embodiment, the techniques herein are performed by computer system 1600 in response to processor 1604 executing one or more sequences of one or more instructions contained in main memory 1606. Such instructions may be read into main memory 1606 from another storage medium, such as storage device 1610. Execution of the sequences of instructions contained in main memory 1606 causes processor 1604 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may comprise non-volatile media and/or volatile media. Non-volatile media includes, for example, optical or magnetic disks, such as storage device 1610. Volatile media includes dynamic memory, such as main memory 1606. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that comprise bus 1602. Transmission media may also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 1600 may receive the data from the network and place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of transmission media.

Computer system 1600 can send messages and receive data, including program code, through the network(s), network link 1620 and communication interface 1618. In the Internet example, a server 1630 might transmit a requested code for an application program through Internet 1628, ISP 1626, local network 1622, and communication interface 1618.

The received code may be executed by processor 1604 as it is received, and/or stored in storage device 1610, or other non-volatile storage for later execution.

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface, e.g., a web browser, a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider’s applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may implement different network requirements as needed by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID’s. Additionally or alternatively, data structures and/or datasets, stored by the computer network, are tagged with tenant ID’s. A tenant is permitted access to a particular application, data structure, and/or dataset only if the tenant and the particular application, data structure, and/or dataset are associated with a same tenant ID. As an non-limiting example, each database implemented by a multi-tenant computer network may be tagged with a tenant ID. Only a tenant associated with the corresponding tenant ID may access data of a particular database. As another non-limiting example, each entry in a database implemented by a multi-tenant computer network may be tagged with a tenant ID. In this configuration, only a tenant associated with the corresponding tenant ID may access data of a particular entry. However, the database may be shared by multiple tenants. A subscription list may indicate which tenants have authorization to access which applications. For each application, a list of tenant ID’s of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method for generating a visualization of 3D data for a manufactured part, comprising steps of:
scanning a part to obtain a digital representation;
comparing the digital representation with a 3D model; and
generating the visualization of the part having color and pattern shading to display portions of the part that topographically differ between the digital representation and the 3D model.

2. The method of claim 1, wherein the visualization comprises one or more surface peaks and/or valleys that are not present in the 3D model.

3. The method of claim 1, wherein the color and pattern shading of the visualization indicates parts of a surface of the manufactured part that may be topographically out of specification with respect to the 3D model.

4. The method of claim 1, wherein different shades of a color in the visualization indicate different depth ranges of a valley of the digital representation below a surface of the 3D model.

5. The method of claim 1, wherein different shades of a color in the visualization indicate different height ranges of a peak above a surface of the 3D model.

6. The method of claim 1, further comprising setting a threshold for designating a point or area in the visualization as a peak or valley.

7. The method of claim 1, wherein the color and pattern shading of the visualization indicates a difference between the digital representation and the 3D model.

8. The method of claim 7, wherein the color and pattern shading of the visualization indicates a topographical difference between the digital representation and the 3D model by degree or extent.

9. The method of claim 1, comprising configuring parameters of the color and pattern shading of the visualization of the part.

10. The method of claim 8, wherein the visualization displays a change in the color and pattern shading of the visualization when the topographical difference between the digital representation and the 3D model is within an acceptable range.

11. The method of claim 10, wherein the visualization displays a change in the color and pattern shading of the visualization when the topographical difference between the digital representation and the 3D model is greater than the acceptable range.

12. The method of claim 10, wherein the visualization displays a change in the color and pattern shading of the visualization when the topographical difference between the digital representation and the 3D model is less than the acceptable range.

13. The method of claim 1, further comprising translating the color and pattern shading of the visualization to a grayscale visualization.

14. The method of claim 1, wherein the color and pattern shading of the visualization corresponds to an amount and direction of a deviation from an expected parameter in a specification of the manufactured part.

15. The method of claim 1, wherein variations of the color and pattern shading of the visualization correspond to differences in data pertaining to the topographical differences between the digital representation and the 3D model.

16. The method of claim 1, wherein a direction of the pattern shading indicates a peak or valley in the visualization of the part.

17. The method of claim 1, wherein a direction of cross-hatching in the pattern shading indicates a peak or valley in the visualization of the part.

18. The method of claim 1, wherein symbols in the pattern shading indicate a peak or valley in the visualization of the part.

19. A visualization of 3D data for a manufactured part, comprising:
a digital representation of the manufactured part as compared with a 3D model of the part;
the digital representation illustrating the manufactured part having color and pattern shading to display portions of the manufactured part that topographically differ between the digital representation and the 3D model.

20. The visualization of claim 19, wherein the topographically different portions of the part comprise one or more surface peaks and/or valleys that are not present in the 3D model.

21. The visualization of claim 19, wherein the color and pattern shading of the digital representation indicate parts of a surface of the manufactured part that may be topographically out of specification as compared to the 3D model.

22. The visualization of claim 19, wherein different shades of a color in the digital representation indicate different depth ranges of a valley of the manufactured part below a surface of the 3D model.

23. The visualization of claim 19, wherein different shades of a color in the digital representation indicate different heights ranges of a peak of the manufactured part above a surface of the 3D model.

24. The visualization of claim 19, wherein the color and pattern shading of the digital representation indicates a difference between the manufactured part and the 3D model.

25. The visualization of claim 24, wherein the color and pattern shading of the digital representation indicates a topographical difference between the manufactured part and the 3D model by degree or extent.

26. The visualization of claim 19, wherein a direction in the pattern shading of the digital representation indicates a peak or valley of the manufactured part.

27. The visualization of claim 19, wherein cross-hatching in the pattern shading of the digital representation indicate a peak or valley of the manufactured part.

28. The visualization of claim 19, wherein symbols in the pattern shading of the digital representation indicate a peak or valley of the manufactured part.
